(19) United States
(12) Patent Application Publication
(10) Pub. No.: US 2024/0311999 A1
(43) Pub. Date: Sep. 19, 2024

(54) AUTOMATIC DETECTION OF VARIATION IN PRODUCTION PROCESS

(71) Applicant: AI QUALISENSE 2021 LTD, Tel Aviv-Yafo (IL)

(72) Inventor: Adam Zrehen, Tel Aviv-Yafo (IL)

(73) Assignee: AI QUALISENSE 2021 LTD, Tel Aviv-Yafo (IL)

(21) Appl. No.: 18/607,322

(22) Filed: Mar. 15, 2024

Related U.S. Application Data
(60) Provisional application No. 63/490,516, filed on Mar. 15, 2023.

(51) Int. Cl. G06T 7/00

(52) U.S. Cl. CPC G06T 7/001; G06T 2207/20081

(57) ABSTRACT

A method for detecting process variations in a manufacturing process, the method includes receiving an image of an evaluated manufactured item (EMI), the EMI was manufactured by the manufacturing process; generating EMI patches representations that are related to the EMI; wherein the EMI patches representations of the EMI are selected out of (a) representations of patches of the image of the EMI, or (b) patches of a representation of the image of the EMI; determining EMI patches representations scores, wherein an EMI patch representation score of a certain EMI patch representation is determined based on (a) one or more similarities between the certain EMI patch representation and one or more reference concepts of multiple reference concepts, and (b) one or more similarity thresholds of the one or more reference concepts; and determining a process variation score based on at least some of EMI patches representations scores.

### BACKGROUND OF THE INVENTION

Manufactures items may be generated by manufacturing process that may change over time.

The changes may not be known in advance or may be difficult to detect without prior knowledge of the expected defects resulting from the process variations.

There is a growing need to provide a method for detecting process variation even without prior knowledge of what are the impact of such process variations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a comparison and a data structures;

FIG. 3 illustrated an example of a comparison; and

FIG. 4 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There may be provided a method for detecting process variations that is based on scores of multiple patch representations related to an evaluated manufactured item (EMI).

According to one example, similarities between each patch representation and multiple reference concepts are calculated. Each reference concept is also associated with a similarity threshold. One or more differences (also referred to depths) between one or more similarities and one or more similarity thresholds of one or more reference concepts are also calculated. A score is calculated for each patch representation (based on the similarities and differences). A process variation score may be calculated based scores of multiple patches. The multiple reference concepts and their associated similarity thresholds represent the state of items manufactured by the manufacturing process at a certain point of time. When process variations occur the differences between the manufacture items and the multiple reference concepts increase—and the process variation score may provide an indication of the occurrence of such differences.

The method is highly effective and does not require prior knowledge of the impact of process variations on the manufactured items.

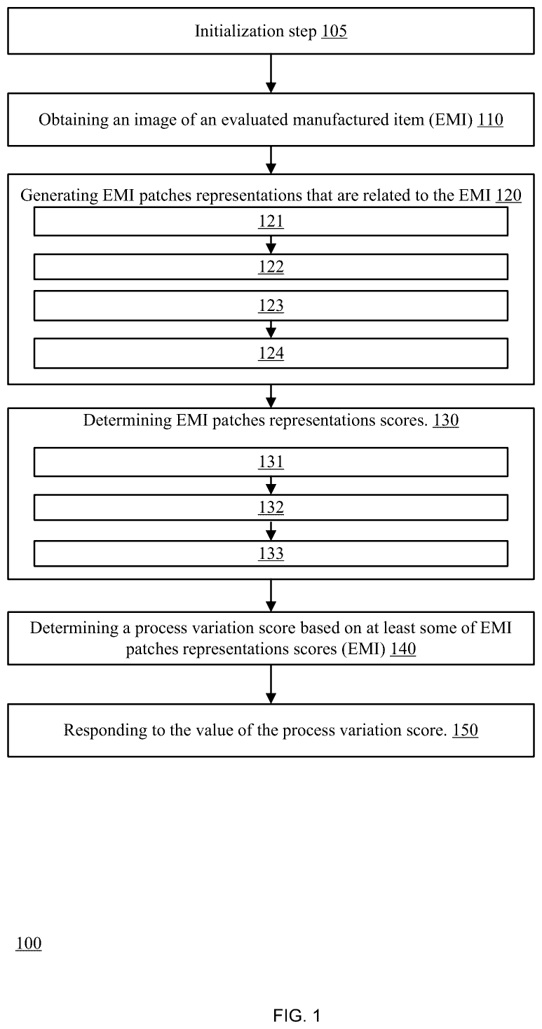

FIG. 1 illustrates a method 100 for detecting process variations in a manufacturing process.

Method 100 may start by initialization step 105. Initialization step 105 may include obtaining reference patches and reference patches representations. The reference patches representations may also be referred to as concepts.

A reference patch representation may be a representation of a patch of an image of a reference manufactured item.

The reference patches may be obtained from one or more images of one or more reference manufactured items.

A reference patch representation may be a patch of a representation a reference manufactured item.

Training patches may be compared to the reference patches (for example—by comparing between training patches representations and reference patches representations).

For each reference patch, the highest N similarity scores are found and a similarity threshold is defined to distinguish between the N'th highest similarity score and the (N+1)'th highest similarity score is defined. N may be defined in any manner—for example based on a expected percent of functional or non-defective manufactured items. N may range between 2-10, 20-50, 40-110, 100-500, and more).

Method 100 may also include step 110 of obtaining an image of an evaluated manufactured item (EMI), the EMI was manufactured by the manufacturing process.

Step 110 may be followed by step 120 of generating EMI patches representations that are related to the EMI.

The EMI patches representations of the EMI may be representations of patches of the image of the EMI. In this case step 120 may include step 121 of partitioning an image of the EMI to patches, and step 122 of generating representations of the patches of the image of the EMI.

The EMI patches representations of the EMI may be patches of a representation of the image of the EMI. In this case step 120 may include step 123 of generating a representation of the image of the EMI and step 124 of partitioning the representation to patches.

The representations may be signatures of the reference MIP candidates. Examples of signature generations are illustrated in US patent application publication serial number US2020311470A1 which is incorporated herein by reference. The signature may be a list of indexes.

The representations may be one or more features (even one or more feature map) generated by of one or more layers of one or more neural network that is fed by (at least) the reference MIP candidates.

The representations may be models—such as deep learning models of the reference MIPS candidates.

Step 120 may be followed by step 130 of determining EMI patches representations scores.

An EMI patch representation score of a certain EMI patch representation is determined based on (a) one or more similarities between the certain EMI patch representation and one or more reference concepts of multiple reference concepts, and (b) one or more similarity thresholds of the one or more reference concepts.

A similarity threshold may be defined as a minimum similarity required between an evaluated patch and a reference patch for the evaluated patch to be considered sufficiently similar to the reference patch.

Step 130 may include step 131 of determining one or more similarities between the certain EMI patch representation and one or more reference concepts of multiple reference concepts. The one or more reference concepts may include all reference concepts, some (two or more) of the reference concepts or a single reference concept.

The similarity may be a cosine similarity or any other similarity metric—for example Euclidean distance, Dot product, and the like.

Step 131 may be followed by step 132 of determining relationships between the one or more similarities and one or more similarity threshold. The relationships may be a difference or any other relationship parameter.

For example—assuming that there are K reference concepts and J EMI patch representations—then for each j between 1 and J the j'th EMI patch representation is compared to these K reference concepts—to provide (for the j'th EMI patch representation) K similarity scores S(j,1)−S(j,K) and K differences D(j,1)−D(j,K), whereas D(j,k)=ST(k)−S(j,m), whereas k ranges between 1 and K, and ST(k) is the similarity threshold of the k'th reference concept.

For the j'th EMI patch a single difference value may be selected—for example it may be an average of D(j,1)−D(j,K), a minimal value of D(j,1)−D(j,K), a median value of D(j,1)−D(j,K), it may be a weighted average of D(j,1)−D(j,K), a weighted minimum value of D(j,1)−D(j,K), a weighted medial value of D(j,1)−D(j,K), or any other function. An example of the weight is the similarity threshold divided by the number of training images, or is the similarity threshold divided by a product of the number of training images and a percent of faulty or proper training manufacture items.

Step 132 may be followed by step 133 of determining a EMI patch representation score of one or more—and even all EMI patch representations. Wherein an EMI patch representation score of a certain EIM path representation is based on the one or more similarities of step 131 and/or on the one or more relationships of step 132

For the j'th EMI patch the EMI patch representation score may be calculated—for example it may be an average of D(j,1)−D(j,K), a minimal value of D(j,1)−D(j,K), a median value of D(j,1)−D(j,K), it may be a weighted average of D(j,1)−D(j,K), a weighted minimum value of D(j,1)−D(j,K), a weighted medial value of D(j,1)−D(j,K), or any other function. An example of the weight is the similarity threshold divided by the number of training images, or is the similarity threshold divided by a product of the number of training images and a percent of faulty or proper training manufacture items.

Step 130 may be followed by step 140 of determining a process variation score based on at least some of EMI patches representations scores. The value of the process variation score may be indicative of whether the EMI is indicative of a process variation.

The process variation score may be any function of the EMI patches representations scores—for example it may be an average of the EMI patches representations scores.

Step 140 may be followed by step 150 of responding to the value of the process variation score.

The values of the process variation scores taken at different times may be compared to provide an indication of a process variation. a certain amount of change in the process variation score (for example—a change of at least 10, 15, 20, 25, 30, 35, 40 percent or more) may be indicative of a process variation.

Step 140 may include determining that there is a process variation and sending (transmitting) a process variation alert, storing the process variation alert, storing and/or sending values of process variation scores obtained over a period of time (day, week, month, and the like).

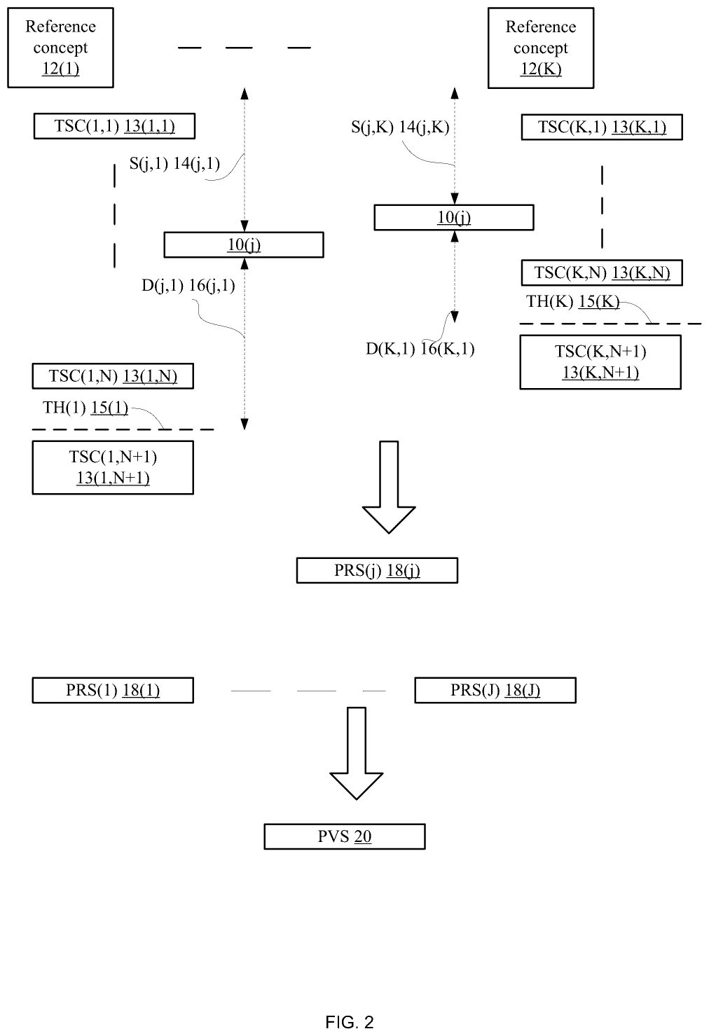

FIG. 2 illustrates an example of various data structures and metrices.

FIG. 2 illustrates a comparison of a j'th EMI patch 10(j) to K reference concepts 12(1)-12(K)—to provide K similarity scores S(j,1)−S(j,K) 14(j,1)−14(j,K) and K differences D(j,1)−D(j,K) 16(j,1)−16(j,K).

FIG. 2 also illustrates the (N+1)'th highest training similarity scores for each of the K reference concepts {TSC(1,1)−TSC(1,N+1) 13(1,1)−13(1,N+1) till . . . TSC(K,1)J−TSC(K,N+1) (13(K,1)−13(K,N+1)} and the K similarity thresholds TH(1)−TH(K) 15(1)−15(K).

FIG. 2 also illustrates J EMI patches representations scores PRS 18(1)-18(J) and a process variation score PVS 20.

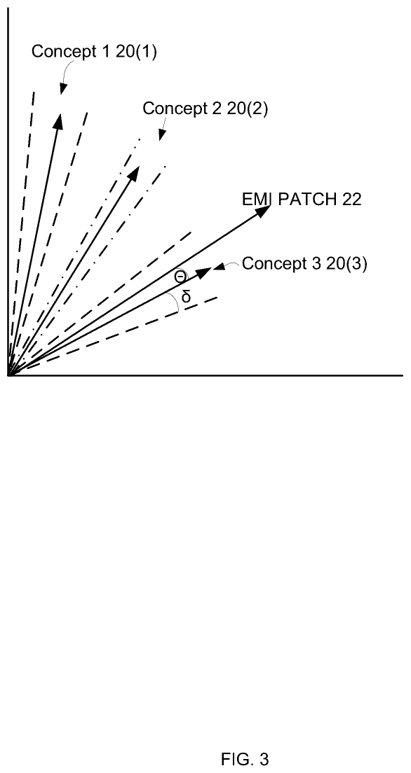

FIG. 3 illustrates an example of feature vector 22 is a EMI patch representation and three reference concepts 20(1), 20(2) and 20(3) having borders (dashed lines) that are defined (are distance from each other) by their similarity thresholds.

There are three reference concepts.

In FIG. 3, angle θ is the angle made between the inference patch vector and third second concept 20(2) vector. Angle δ is the angle made between the third second concept 20(2) boundary vector and the third second concept 20(2) vector. An example calculation of EMI patch representation score based on FIG. 3 is illustrated below:

| | First concept | Second concept | Third second concept |
|---|---|---|---|
| | 20(1) | 20(2) | 20(2) |
| Concept Size % | 20 | 20 | 20 |
| Number of | 200 | 200 | 200 |
| Training Images | | | |
| Training Images | 40 | 40 | 40 |
| per Concept | | | |
| Threshold Angle | δ₁ = 15° | δ₂ = 5° | δ₃ = 25° |
| Threshold | 0.9659 | 0.9962 | 0.9063 |
| Threshold | 0.0008525 | 0.000095 | 0.0023425 |
| Granularity | | | |
| Similarity Angle | θ₁ = 55° | θ₁ = 35° | θ₁ = 10° |
| Similarity | 0.5736 | 0.8191 | 0.9848 |
| φ = (Similarity − | 460 | 1864 | −33 |
| Threshold)/ | | | |
| Granularity | | | |

| | |
|---|---|
| EMI patch | −33 |
| representation | |
| score | |

In the above example, the similarity angles of the inference patch vector with first concept 20(1) and second concept 20(2) vectors are large compared to that with third second concept 20(2). Other conceivable scenarios may include small similarity angles with all the concepts. As may be understood from the calculation, a concept with a very high threshold (and subsequently a very small threshold granularity) is more difficult to enter than a concept with a very small threshold. This is reflected in the much higher o obtained with second concept 20(2) despite the smaller similarity angle. In simplified terms, the inference patch is much farther from second concept 20(2) than first concept 20(1).

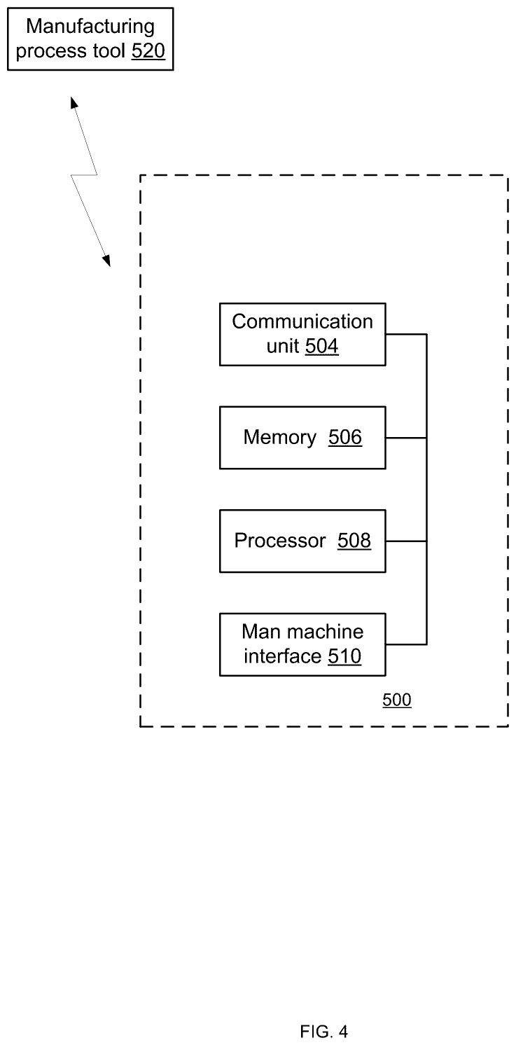

FIG. 4 is an example of a computerized system 500 and a manufacturing process tool 520.

The computerized system 500 may execute method 100.

The computerized system 500 may or may not communicate with the manufacturing process tool 520. It may, for example, provide feedback (for example the process variation alert) about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include communication unit 504, memory 506, processor 508 and may optionally include a man machine interface 510.

Processor may execute the steps of method 100, Memory 506 is configured to store any data element illustrated in FIG. 2.

Any of the suggested method may be executed by a computerized device that may include one or more processing circuits, memory for storing images and/or anomaly spatial information and/or instructions and/or the outcome of method 100, and a communication unit for communication with other systems and/or devices.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for detecting process variations in a manufacturing process, the method comprises:
receiving an image of an evaluated manufactured item (EMI), the EMI was manufactured by the manufacturing process;
generating EMI patches representations that are related to the EMI; wherein the EMI patches representations of the EMI are selected out of (a) representations of patches of the image of the EMI, or (b) patches of a representation of the image of the EMI;
determining EMI patches representations scores, wherein an EMI patch representation score of a certain EMI patch representation is determined based on (a) one or more similarities between the certain EMI patch representation and one or more reference concepts of multiple reference concepts, and (b) one or more similarity thresholds of the one or more reference concepts; and
determining a process variation score based on at least some of EMI patches representations scores.

2. The method according to claim 1 wherein an EMI patch representation score of a certain EMI patch representation is determined based on (a) similarities between the EMI patch representation and each one of the multiple reference concepts, and (b) similarity thresholds of each one of the multiple reference concepts.

3. The method according to claim 1 wherein an EMI patch representation score of a certain EMI patch representation is determined based on (a) similarities between the EMI patch representation and each one of some of the multiple reference concepts, and (b) similarity thresholds of each one of some of the multiple reference concepts.

4. The method according to claim 1 wherein an EMI patch representation score of each EMI patch representation is determined based on (a) similarities between the EMI patch representation and two or more reference concepts of the multiple reference concepts, and (b) similarity thresholds of two or more reference concepts of the multiple reference concepts

5. The method according to claim 1 wherein an EMI patch representation score of a EMI patch representation is determined based on one or more differences between (a) one or more similarities between the EMI patch representation and one or more reference concepts of the multiple reference concepts, and (b) one or more corresponding similarity thresholds of the one or more reference concepts.

6. The method according to claim 5 wherein a reference concept is associated with a first number (N) of highest training similarity scores; wherein a similarity threshold of the reference concept separates between an N'th highest training similarity score and any other training similarity score lower than the N'th highest training similarity score.

7. The method according to claim 5 wherein the EMI patch representation score of each EMI patch representation is determined based on one or more differences between (a) the similarity between the EMI patch representation and one or more corresponding reference concepts, and (b) one or more similarity thresholds of the one or more corresponding reference concept.

8. The method according to claim 1 wherein an EMI patch representation score of an EMI patch representation is determined based on a minimal difference out of differences between (a) similarities between the EMI patch representation and reference concepts of the multiple reference concepts, and (b) corresponding similarity thresholds of the reference concepts.

9. The method according to claim 1 wherein an EMI patch representation score of an EMI patch representation is determined based on an average of differences between (a) similarities between the EMI patch representation and reference concepts of the multiple reference concepts, and (b) corresponding similarity thresholds of the reference concepts.

10. The method according to claim 1 wherein the one or more similarity thresholds of the one or more reference concepts are calculated during a training process.

11. The method according to claim 10 wherein the training process comprises obtaining reference concepts that are patches of one or more reference images.

12. A non-transitory computer readable medium for detecting process variations in a manufacturing process, the non-transitory computer readable medium storage instructions that cause a processor to:
receive an image of an evaluated manufactured item (EMI), the EMI was manufactured by the manufacturing process;
generate EMI patches representations that are related to the EMI; wherein the EMI patches representations of the EMI are selected out of (a) representations of patches of the image of the EMI, or (b) patches of a representation of the image of the EMI;
determine EMI patches representations scores, wherein an EMI patch representation score of a certain EMI patch representation is determined based on (a) one or more similarities between the certain EMI patch representation and one or more reference concepts of multiple reference concepts, and (b) one or more similarity thresholds of the one or more reference concepts; and
determine a process variation score based on at least some of EMI patches representations scores.

13. The non-transitory computer readable medium according to claim 12, wherein an EMI patch representation score of a certain EMI patch representation is determined based on (a) similarities between the EMI patch representation and each one of the multiple reference concepts, and (b) similarity thresholds of each one of the multiple reference concepts.

14. The non-transitory computer readable medium according to claim 12, wherein an EMI patch representation score of each EMI patch representation is determined based on (a) similarities between the EMI patch representation and two or more reference concepts of the multiple reference concepts, and (b) similarity thresholds of two or more reference concepts of the multiple reference concepts

15. The non-transitory computer readable medium according to claim 12, wherein an EMI patch representation score of a EMI patch representation is determined based on one or more differences between (a) one or more similarities between the EMI patch representation and one or more reference concepts of the multiple reference concepts, and (b) one or more corresponding similarity thresholds of the one or more reference concepts.

16. The non-transitory computer readable medium according to claim 15 wherein a reference concept is associated with a first number (N) of highest training similarity scores; wherein a similarity threshold of the reference concept separates between an N'th highest training similarity score and any other training similarity score lower than the N'th highest training similarity score.

17. The non-transitory computer readable medium according to claim 15 wherein the EMI patch representation score of each EMI patch representation is determined based on one or more differences between (a) the similarity between the EMI patch representation and one or more corresponding reference concepts, and (b) one or more similarity thresholds of the one or more corresponding reference concept.

18. The non-transitory computer readable medium according to claim 12, wherein an EMI patch representation score of an EMI patch representation is determined based on a minimal difference out of differences between (a) similarities between the EMI patch representation and reference concepts of the multiple reference concepts, and (b) corresponding similarity thresholds of the reference concepts.

19. The non-transitory computer readable medium according to claim 12, wherein the one or more similarity thresholds of the one or more reference concepts are calculated during a training process.

20. The non-transitory computer readable medium according to claim 19 wherein the training process comprises obtaining reference concepts that are patches of one or more reference images.
